(19) United States
(12) Patent Application Publication
(10) Pub. No.: US 2017/0324488 A1
(43) Pub. Date: Nov. 9, 2017

(54) METHOD AND APPARATUS FOR EVALUATING NODE PERFORMANCE AND SYSTEM

(71) Applicant: FUJITSU LIMITED, Kawasaki-shi (JP)

(72) Inventors: Su YI, Beijing (CN); Hao Wang, Beijing (CN); Jun Tian, Beijing (CN); Xiaojing Fan, Beijing (CN); Lefei Wang, Beijing (CN); Wenqian Xue, Beijing (CN); Ryuichi Matsukura, Kawasaki-shi (JP)

(73) Assignee: FUJITSU LIMITED, Kawasaki-shi (JP)

(21) Appl. No.: 15/587,101

(22) Filed: May 4, 2017

(30) Foreign Application Priority Data
May 9, 2016 (CN) 201610301196.7

(51) Int. Cl. H04B 17/309; H04L 29/06; H04W 24/02; H04L 12/26; H04W 24/08

(52) U.S. Cl. CPC H04B 17/309; H04W 24/02; H04L 43/062; H04L 65/80; H04W 24/08

(57) ABSTRACT

Embodiments of this disclosure provide a method and apparatus for evaluating node performance and a system. The method includes: real-time communication related information of a network node is collected; normalization on the test data within the predetermined period of time is performed by using preobtained best data vectors and worst data vectors, so as to obtain normalized multi-dimensional vectors of the test data within the period of time; and the normalized multi-dimensional vectors of the test data within the period of time is weighted, distance from the weighted normalized multi-dimensional vectors to the best data vectors is calculated, and a grade of the network node is determined according to the distance and a predefined monotonically decreasing function. With the embodiments of this disclosure, by collecting real-time communication related information of a network node in a wireless network, performing statistical analysis on the collected information, and performing node performance evaluation by using a method for comparing the training data and the test data, thereby providing references for network service providers in performing network optimization.

### FIELD

This disclosure relates to the field of communication technologies, and in particular to a method and apparatus for evaluating node performance and a system.

### BACKGROUND

The Internet of Things (IoT) has become a powerful force for business transformation, and its disruptive impact will be felt across all industries and all areas of society. The entities in IoT networks usually include sensors and devices, gateway, networks, cloud, and applications.

With this growing adoption of the technology and increasing dependence on wireless local area networks (WiFi), wireless personal area networks (Zigbee), Bluetooth, and other wireless short-range networks, users are beginning to demand reliability, performance, scalability and ubiquitous coverage from the wireless networks. However, existing sensor network deployment provides inadequate coverage and unpredictable performance. The reasons leading to the degraded performance include dense deployment, noise and interference, radio frequency (RF) effects such as hidden terminals, and limitations in the medium access control (MAC) layer. And unlike the wired counterpart, a wireless link is easily affected by environment changes or surrounding wireless activities. State monitoring and failure diagnosis in both link level and network level are essential components to operate an IoT network. One means for state monitoring is to perform performance evaluation on each node in a network. The performance of a network node relates to multiple factors, including some nonquantitative factors, thereby resulting in subjectivity and indeterminacy in the network performance evaluation.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that performance of a wireless network is affected by multiple factors, especially those factors that may be deemed as failures (troubles or faults) or errors. Among all the failures or errors, what most common and frequent are those related to wireless transmission. Such errors are generally caused by random fading, low received signal strength and interference. These root causes are common to all short-range wireless networks. Furthermore, such standards as IEEE 802.11, 802.15.4, and 802.15.1, etc., operate in unauthorized frequency bands, and as multiple systems interfere with each other and the number of users in the unauthorized frequency bands increases rapidly, some problems, such as interference, become more critical. And as the interference is unpredictable due to that it is generated by moving users, other unauthorized frequency band modules and varying traffic amounts, for high-efficiency operations and administrative services, real-time state monitoring and node performance evaluation are needed.

In order to solve the above problems, embodiments of this disclosure provide a method and apparatus for evaluating node performance and a system, in which by giving a performance grade for each equipment in a wireless network, IoT service providers may pay attention to some problems affecting the performance or avoid potential problems.

According to a first aspect of the embodiments of this disclosure, there is provided an apparatus for evaluating node performance, including:

a collecting unit configured to collect real-time communication related information of a network node, so as to obtain test data of the network node within a predetermined period of time, the test data including one or more of the following or a combination thereof:
a packet drop ratio;
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

a processing unit configured to perform normalization on the test data within the predetermined period of time by using preobtained best data vectors and worst data vectors, so as to obtain normalized multi-dimensional vectors of the test data within the period of time; and

a determining unit configured to weight the normalized multi-dimensional vectors of the test data within the period of time, calculate distance from the weighted normalized multi-dimensional vectors to the best data vectors, and determine a grade of the network node according to the distance and a predefined monotonically decreasing function.

According to a second aspect of the embodiments of this disclosure, there is provided a control entity in a wireless network, including the apparatus for evaluating node performance described in the first aspect.

According to a third aspect of the embodiments of this disclosure, there is provided a communication system, including a coordinator and a terminal equipment in communication with the coordinator; wherein, the communication system further includes the control entity described in the second aspect.

According to a fourth aspect of the embodiments of this disclosure, there is provided a method for evaluating node performance, including:

real-time communication related information of a network node is collected, so as to obtain test data of the network node within a predetermined period of time, the test data including one or more of the following or a combination thereof:
a packet drop ratio;
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

normalization on the test data within the predetermined period of time is performed by using preobtained best data vectors and worst data vectors, so as to obtain normalized multi-dimensional vectors of the test data within the period of time; and

the normalized multi-dimensional vectors of the test data within the period of time is weighted, distance from the weighted normalized multi-dimensional vectors to the best data vectors is calculated, and a grade of the network node is determined according to the distance and a predefined monotonically decreasing function.

An advantage of the embodiments of this disclosure exists in that with the method, apparatus and system of the embodiments of this disclosure, by collecting real-time communication related information of a network node in a wireless network, performing statistical analysis on the collected information, and performing node performance evaluation by using a method for comparing the training data and the test data, thereby providing references for network service providers in performing network optimization.

With reference to the following description and drawings, the particular embodiments of this disclosure are disclosed in detail, and the principles of this disclosure and the manners of use are indicated. It should be understood that the scope of the embodiments of this disclosure is not limited thereto. The embodiments of this disclosure contain many alternations, modifications and equivalents within scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the exemplary embodiments of this disclosure, and are used for setting forth the principles of this disclosure together with the description. It is clear and understood that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a common architecture of a front-end management system of the IoT;

FIG. 2 is a schematic diagram of an apparatus for evaluating node performance of Embodiment 1;

FIG. 3 is a schematic diagram of a grading process of the apparatus of Embodiment 1;

FIG. 4 is a schematic diagram of a data model constructed by the apparatus of Embodiment 1;

FIG. 5 is a graph of a grade as a function of a modulus of D;

FIG. 6 is a schematic diagram of a simple example of data points and distances;

FIG. 7 is a schematic diagram of a control entity of Embodiment 2;

FIG. 8 is a schematic diagram of a communication system of Embodiment 3; and

FIG. 9 is a schematic diagram of a method for evaluating node performance of Embodiment 4.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within terms of the appended claims.

The method of the embodiment of this disclosure is applicable to the IoT, a sensor network, a wireless local area network (WLAN), and other wireless networks. In the embodiments of this disclosure, for the sake of convenience of explanation, terminologies in the IoT are used, and some contexts related to specifications are based on IEEE 802.15.4. Such an idea can be easily extended to other wireless communication systems and other wireless standards.

FIG. 1 is a schematic diagram of a common architecture of a front-end management system of the IoT. As shown in FIG. 1, a gateway (GW) supports connection from a front-end connectivity devices to back-end application analysis. In particular, front-end devices for various applications and various network systems have different management demands, and the gateway provides a common application interface (API) for different devices, networks to cloud and customer supports, so as to meet application demands of the customer. After the front-end devices (including an access point (AP), a hub, and a router, etc.) collect transceiver logs, the logs will be transmitted to the gateway. According to application demands and analysis complexity, the AP, the GW, a central controller, a cloud, or a service layer will determine a grade of performance for each network device.

The embodiments of this disclosure shall be described below with reference to the accompanying drawings and particular implementations.

### Embodiment 1

An embodiment of this disclosure provides an apparatus for evaluating node performance, which is used in a wireless network. The apparatus may be applicable to a coordinator, an access point (AP), a hub, a central controller, or a cloud, etc. A particular implementation environment is dependent on the wireless network. For the sake of convenience of explanation, this embodiment shall be described taking a coordinator as an example.

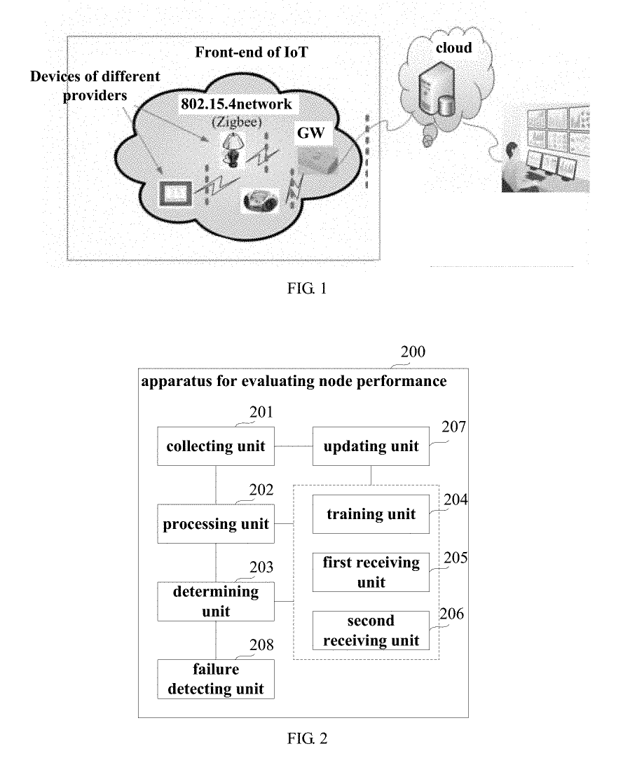

FIG. 2 is a schematic diagram of the apparatus. As shown in FIG. 2, the apparatus 200 includes a collecting unit 201, a processing unit 202 and a determining unit 203, the collecting unit 201 is configured to collect real-time communication related information of a network node, so as to obtain test data of the network node. The processing unit 202 is configured to perform normalization on the test data within a predetermined period of time by using preobtained best data vectors and worst data vectors, so as to obtain normalized multi-dimensional vectors of the test data within the period of time. And the determining unit 203 is configured to weight the normalized multi-dimensional vectors of the test data within the period of time, calculate a distance from the weighted normalized multi-dimensional vectors to the best data vectors, and determine a grade of the network node according to the distance and a predefined monotonically decreasing function. In particular implementation, the processing unit 202 and the determining unit 203 may be combined into a calculating module.

In this embodiment, the network node refers to terminal equipment in the wireless network, and performance evaluation of each network node may be based on an internal state of the network node, and may also be based on a state of a wireless link between the network node and a coordinator, a finally obtained grade indicating a position, a power level, and a channel condition, etc., of the network node.

In this embodiment, the coordinator refers to a network entity functioning to coordinate in the wireless network, such as a coordinator, an access point (AP), and a hub, etc., which may be named differently according to different types of wireless networks. This embodiment is described taking a coordinator as an example, but it is not limited thereto. In this embodiment, the terminal equipment refers to nodes in the wireless network, such as a station, a node, etc., which, likewise, may be named differently according to different types of wireless networks. For the sake of convenience of explanation, they are collectively referred to as terminal equipment in this embodiment.

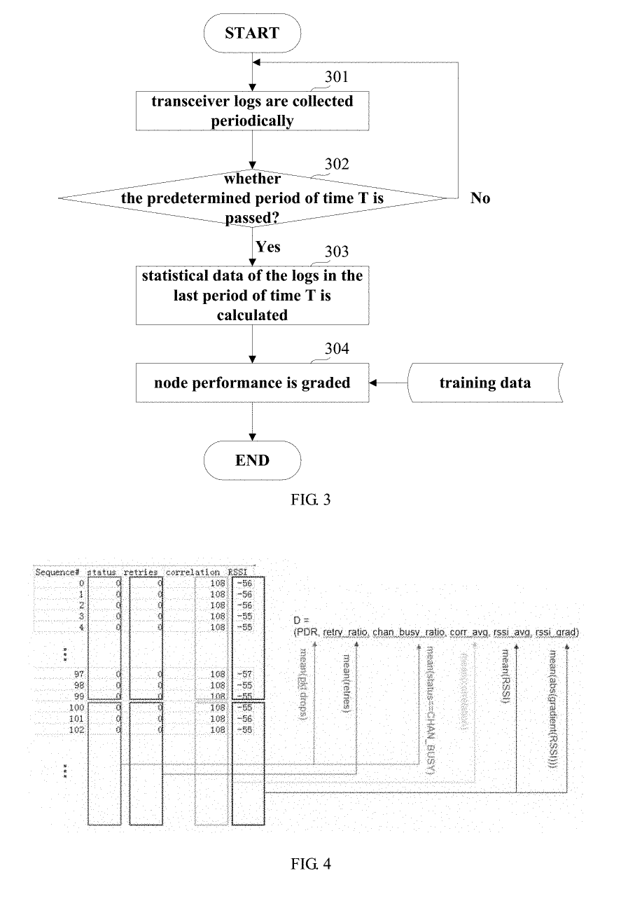

FIG. 3 is a schematic diagram of a grading process of the apparatus 200. As shown in FIG. 3, the process includes:

step 301: transceiver logs are collected periodically;

in this embodiment, at beginning of detection or monitoring, that is when detection or monitoring begins, the collecting unit 201 begins to periodically collect the transceiver logs, the transceiver logs containing the real-time communication related information of the network node;

in this embodiment, in order to evaluate performance of the network node, several transceiver logs may be selected for analysis; whether TX logs (transmitter logs) or RX logs (receiver logs) are selected is decided according to whether the coordinator is a transmitter or a receiver in a data packet communication process; for example, for IoT services, there exist some fixed service modes generally; for example, for some services similar to data collection applications, the sensor equipment needs to periodically transmit data to the coordinator, in which case the RX logs may be collected based on existing application data; if the service modes are other manners, on the contrary, the TX logs may be collected; if the services are not periodical, the coordinator may periodically transmit some sounding packets, and then collect the TX logs based on these sounding packets; and the TX logs and the RX logs may be combined in a certain manner to form general statistical data;

step 302: whether the predetermined period of time T is passed is judged, and step 303 is executed if it is judged yes, otherwise, step 301 is executed;

step 303: statistical data of the logs in the last period of time T is calculated;

in this embodiment, for each period of time T, the processing unit 202 calculates the statistical data of the logs in the last period of time T to obtain the test data (the multi-dimensional feature vectors), and obtain a normalized value of the test data by performing normalization on the test data;

step 304: node performance is graded;

in this embodiment, the determining unit 203 evaluates each equipment by using a grading algorithm, and reports a grade result.

In this embodiment, some training data are predefined for data statistics and grading analysis, which shall be described in detail below. In this embodiment, the process occurs periodically, until the grading or the monitoring is stopped (disabled). Hence, each network node will report a grade at each period of time T, which is taken as a performance evaluation result of the network node.

In this embodiment, by collecting the real-time communication related information of the network node in the wireless network, performing statistical analysis on the collected information, and performing node performance evaluation by using a method for comparing the training data and the test data, thereby providing references for network service providers in performing network optimization.

In this embodiment, the real-time communication related information of the network node may be collected from the coordinator, that is, the network node is graded only based on coordinator logs; and it may also be collected from the coordinator and the network node in communication with the coordinator, that is, the network node is graded based on coordinator logs and network node logs.

As to the implementation of colleting the real-time communication related information of the network node from the coordinator, the collecting unit 201 may collect the real-time communication related information by self monitoring, communication monitoring and channel monitoring. The self monitoring mainly includes monitoring a state, and configuration, etc., of the coordinator, such information coming from internal parameters defined in IEEE or other standards. The communication monitoring refers to monitoring network information on packet communication defined in IEEE or other standards, and may also refer to extraction of some communication features, such as a packet error rate, etc. And the channel monitoring refers to monitoring channel information related on physical processes defined in IEEE or other standards, including some channel feature extraction, such as an RSSI, an SINR, etc. By self monitoring, communication monitoring and channel monitoring, the collecting unit 201 may obtain the real-time communication related information of the network node. In this embodiment, the manner of acquiring the real-time communication related information of the network node by the collecting unit 201 is explained taking self monitoring, communication monitoring and channel monitoring as examples. However, this embodiment is not limited thereto, and in particular implementation, the collecting unit 201 may also carry out any one of the above three monitoring manners or any combination thereof, or may further carry out other monitoring processes to obtain the real-time communication related information of the network node.

As to the implementation of colleting the real-time communication related information of the network node from a network node, the collecting unit 201 may perform exchange of some control messages between the coordinator and the network node. For example, the collecting unit 201 may transmit a measurement request packet to the network node, the network node measures related physical parameters of the request packet after obtaining the measurement request packet, and then feeds back a measurement result in a measurement report. Hence, the collecting unit 201 may obtain the real-time communication related information of the network node from the network node.

A manner of collecting the real-time communication related information of the network node by the collecting unit 201 is not limited in this embodiment, and the test data of the network node within the predetermined period of time may be obtained by collecting the communication related information of the network node. In this embodiment, the test data may be a statistical value of the above communication related information. The statistical value may be obtained through calculation, and may be a multi-dimensional feature vector. Hence, the test data may include one or more of the following indices or a combination thereof: a packet drop ratio (PDR), a retry ratio, a channel state busy ratio (chan_busy_ratio), an average value (corr_avg) of correlation values of all acknowledgements (ACKs) within the predetermined period of time, an average value (rssi_avg) of received signal strength indicator (RSSI) values of all the ACKs within the predetermined period of time, and an average value (rssi_grad) of all absolute values of gradients of the RSSIs of all the ACKs within the predetermined period of time.

In this embodiment, as there exist different log statistical modes for different errors, finding related indices reflecting such modes is very important. In this embodiment, use of TX logs is taken as an example; however, this embodiment is not limited thereto, and this method is very easy to be extended to methods based on RX logs and any other combinations of the indices. For example, TX logs of each data packet may include a transmission state (success, failure states) of the data packet, the number of retries of the packet, correlation values of ACKs of the packet, and RSSI values of the ACKs, etc. In this embodiment, more log information may be added, or the above log information may be modified, so as to be adapted to different system specifications. For each period of time T, some statistical value of these log information may be calculated and taken as test data of the network node. For example, a data model is constructed to be as shown in FIG. 4, and a statistical value of the TX logs within the period of time T is used to generate a 6-dimensional feature vector, which is taken as the test data of the network node within the period of time T, the 6-dimensional feature vector being used as a data point in the grading method. Furthermore, weights may be used for each dimension of the 6-dimensional feature vector, so as to reflect importance of different levels of the index.

As shown in FIG. 4, it is assumed that there exist N log samples within the period of time T, for example, N=100. If there exist multiple network nodes in communication with the coordinator, the logs may be filtered via IDs of the network nodes, and all statistical data will be identified as per each network node. And based on the statistical data of the N samples collected from the TX logs, the test data is defined as the above-described 6-dimensional feature vector.

In the 6-dimensional feature vector, the PDR refers to packet drop ratios of N transmission packets, which may be derived from TX status fields (non-zero state means packet drop). The retry_ratio refers to a ratio of a sum of retransmitted data packets to N. The chan_busy_ratio refers to a ratio of the number of times of turning back to a channel busy state to N packets. The corr avg is an average value of correlation values of all ACKs within the period of time T. The rssi_avg is an average value of RSSI values of all the ACKs within the period of time T. And the rssi_grad is an average value of all absolute values of gradients of RSSI data value sequences of all the ACKs within the period of time T; that is, the RSSI values of the ACK frames within the period of time T temporally form a group of RSSI data values, absolute values of numeral gradients of points of this group of data are averaged, and the obtained average value is the rssi_grad.

In this embodiment, levels of performance degradation may be reflected by the above-described 6-dimensional feature vector. However, taking the above-described 6-dimensional feature vector as the test data is illustrative only, and in particular implementation, a combination of many statistical values may be used to construct the above data model D.

In this embodiment, after the test data of the network node is obtained by the collecting unit 201, the processing unit 202 may perform normalization on the test data within the predetermined period of time by using preobtained best data vectors and worst data vectors.

In an implementation of this embodiment, the best data vectors and worst data vectors may be obtained by training. As shown in FIG. 2, in this implementation, the apparatus 200 may further include a training unit 204 configured to collect communication related information of all nodes in a wireless network in different training circumstances within a predetermined period of time to obtain training data, and find out the best data vectors and worst data vectors according to all training data of all the nodes.

In this implementation, the training data may be pre-collected under different conditions, which may be fulfilled by creating several interested errors manually, or may be fulfilled automatically by using an on-line training method. In this embodiment, if the grading method is used together with fault diagnosis, the training data may be labeled as different wireless transmission errors, such as being labeled as a normal state, short-term fading, low received signal strength, and interference. Such four states are very common in a wireless system, and they behave differently in terms of the pattern of the log statistics. If the grading method is used independently, fault diagnosis is not needed, then there is no need to label the training data.

In this implementation, similar to the test data, the training data may also be a statistical value obtained by performing statistics on the above communication related information. The statistical value is a multi-dimensional feature vector containing multiple indices, and the indices contained in it are identical to those contained in the above test data, which may be one or more of the following indices or any combination thereof: a packet drop ratio, a retry ratio, a channel state busy ratio, an average value of correlation values of all ACKs within the predetermined period of time, an average value of RSSI values of all the ACKs within the predetermined period of time, and an average value of all absolute values of gradients of the RSSIs of all the ACKs within the predetermined period of time. And the training unit 204 may take a best value of each index in all training data within the predetermined period of time as the best data vector, and take a worst value of each index in all training data within the predetermined period of time as the worst data vector. Hence, a multi-dimensional best data vector (used as a normalized best point) and a multi-dimensional worst data vector (used as a normalized worst point) are obtained by the training unit 204.

In another implementation of this embodiment, the best data vector and the worst data vector may be obtained from the coordinators. As shown in FIG. 2, in this implementation, the apparatus 200 may further include a first receiving unit 205 configured to receive best data vectors and worst data vectors reported by the coordinators; hence, the processing unit 202 performs the normalization on the test data of the network node within the predetermined period of time by using the best data vectors and worst data vectors reported by the coordinators. That is, in this implementation, different grading criteria are adopted for different terminal equipment in communication with different coordinators. For example, for a certain terminal equipment, it is graded and analyzed by using a best data vector and a worst data vector reported by a coordinator in communication with it. In this implementation, the coordinators may use the above-described training manner to obtain respective best data vectors and worst data vectors and report them.

In a further implementation of this embodiment, the best data vector and the worst data vector may be obtained from the coordinators. As shown in FIG. 2, in this implementation, the apparatus 200 may further include a second receiving unit 206 configured to receive best data vectors and worst data vectors reported by coordinators, and select final best data vectors and worst data vectors from all the best data vectors and worst data vectors; hence, the processing unit 202 performs the normalization on the test data of the network node within the predetermined period of time by using the final best data vectors and worst data vectors. That is, in this implementation, for all terminal equipment, the same grading criterion is adopted, the grading criterion being determined based on information reported by the coordinators. In this implementation, the coordinators may use the above-described training manner to obtain respective best data vectors and worst data vectors and report them.

In an implementation of this embodiment, as shown in FIG. 2, the apparatus 200 may further include an updating unit 207 configured to, when an index of the test data collected by the collecting unit 201 exceeds a range of a corresponding index in the best data vectors or the worst data vectors, save the index of the test data as a corresponding index in new best data vectors or new worst data vectors; hence, the processing unit 202 may perform the normalization on the test data of the network node within the predetermined period of time by using the new best data vectors and new worst data vectors.

In this embodiment, the apparatus 200 may further include a storing unit (not shown) configured to store the above training data (the best data vectors and worst data vectors), etc.

In this embodiment, the test data of the network node is obtained by the collecting unit 201, and the processing unit 202 may perform the normalization on the test data within the predetermined period of time by using the preobtained best data vectors and worst data vectors to obtain the normalized multi-dimensional vectors of the test data within the period of time, so that the determining unit 203 grades the performance of the network node within the period of time by using the normalized vectors.

In an implementation, the processing unit 202 may perform the normalization on the test data of the network node within the period of time by using a formula as below:

$${d}^{ i} = \frac{{d}_{test}^{ i} - {d}_{best}^{ i}}{{d}_{worst}^{ i} - {d}_{best}^{ i}} ;$$

where, dⁱ is an i-th dimension of the normalized multi-dimensional vectors, dⁱₜₑₛₜ is an i-th dimension of the test data of the network node within the period of time, dⁱ_{best} is an i-th dimension of the best data vectors, and dⁱ _{worst} is an i-th dimension of the worst data vectors.

With the above processing, each dimension of vector of the normalized multi-dimensional vectors of the test data is obtained.

This implementation is illustrative only, and this embodiment is not limited thereto. In particular implementation, other normalization methods may also be used to obtain each dimension of vector of the normalized multi-dimensional vectors of the test data.

In this embodiment, after the normalized multi-dimensional vectors of the test data of the network node within the period of time is obtained, the determining unit 203 may grade the performance of the network node.

In an implementation, the determining unit 203 may first weight the normalized multi-dimensional vectors of the test data within the period of time, calculate distance from the weighted normalized multi-dimensional vectors to the best data vectors, and then determine a grade of the network node within the period of time according to the distance and a predefined monotonically decreasing function.

For example, the determining unit 203 may determine a grade of the network node within the period of time by using a formula as below:

$$grade = {e}^{- \frac{\vert w \cdot D \vert}{\vert w \vert}} ⋆ 100 ;$$

where, D is the normalized multi-dimensional vectors of the network node within the period of time (referred to as data points), and w is a weighted vector, each element of w being wᵢ≧0 (i denoting an i-th dimension). According to importance of each dimension of index in the normalized multi-dimensional vectors, weights in the weighted vector corresponding to the indices are different, the higher the importance, the larger the weight.

In this embodiment, the above formulae are illustrative only. In particular implementation, other monotonically decreasing functions or other specifications may be employed to grade the performance of the network node within the period of time based on the normalized multi-dimensional vectors of the network node within the period of time.

FIG. 5 is a graph of a grade as a function of a modulus of D (|D|) with an assumption of no weight (i.e. w is a vector with all-one). As shown in FIG. 5, the grade is a number in a range of (0, 100], and the grading function is a monotonically decreasing function of a modulus of a weighted vector, the shorter a weighted distance from the test data to a best data (a normalized origin), the higher the grade. As all weighted indices are taken into account, if it is more closer to an optical data sample (a normal state), its grade is close to 100, and vice versa.

In an implementation of this embodiment, as shown in FIG. 2, the apparatus 200 may further include a failure detecting unit 208 configured to determine whether there exists a failure in the network node according to a grade of the network node and a threshold value. Hence, a failure of the network node may be decided.

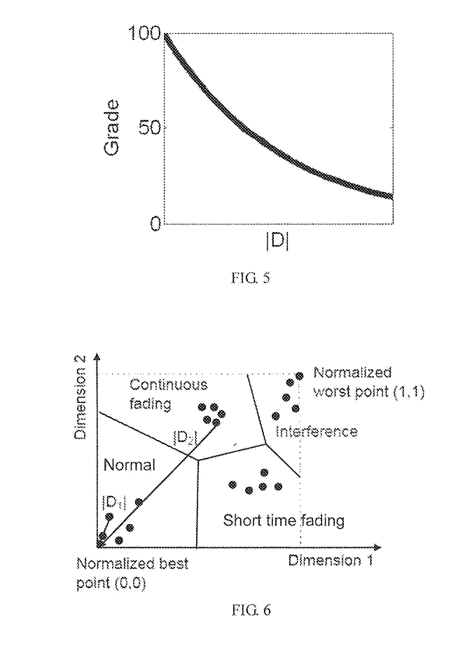

FIG. 6 is a schematic diagram of a simple example of data points and distances. As shown in FIG. 6, in this example, a two-dimensional abstract concept is used to show how to obtain distances of different test data. D₁ and D₂ respectively denote normalized test data from equipment 1 to equipment 2. It can be seen that D₁ has a shorter distance to the normalized best point, hence, equipment 1 has a higher grade. This shows that equipment 1 has communication performance better than that of equipment 2. Furthermore, if a failure detection function is added, a threshold value may be added into the grading process. If the grade is lower than the threshold value, an alarm is given to indicate an equipment failure or a communication link failure between equipment and the coordinator, in which case an administrative individual may take some actions to solve this problem. As shown in FIG. 6, grading and failure diagnosing may be performed in the same process, and in each period of time of diagnosing, a grade may be updated along with a diagnosing result.

With the apparatus of the embodiment of this disclosure, by collecting real-time communication related information of the network node in the wireless network, performing statistical analysis on the collected information, and performing node performance evaluation by using a method for comparing the training data and the test data, thereby providing references for network service providers in performing network optimization.

### Embodiment 2

An embodiment of this disclosure further provides a control entity in a wireless network, such as a coordinator, an access point, a gateway, a central controller, or a cloud. In this embodiment, the control entity includes the apparatus for evaluating node performance as described in Embodiment 1.

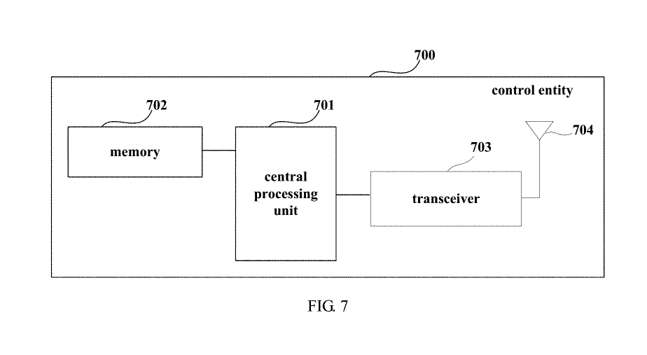

FIG. 7 is a schematic diagram of a structure of an implementation of the control entity of the embodiment of this disclosure. As shown in FIG. 7, the control entity 700 may include a central processing unit (CPU) 701 and a memory 702, the memory 702 being coupled to the central processing unit 701. In this embodiment, the memory 702 may store various data, and furthermore, it may store a program for information processing, and execute the program under control of the central processing unit 701, so as to receive various information transmitted by terminal equipment, and transmit various information to the terminal equipment.

In an implementation, the functions of the apparatus for evaluating node performance described in Embodiment 1 may be integrated into the central processing unit 701, and the central processing unit 701 carries out the functions of the apparatus for evaluating node performance described in Embodiment 1. For example, the central processing unit 701 may be configured to:

collect real-time communication related information of a network node, so as to obtain test data of the network node within a predetermined period of time, the test data including one or more of the following or a combination thereof:
a packet drop ratio;
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

perform normalization on the test data within the predetermined period of time by using preobtained best data vectors and worst data vectors, so as to obtain normalized multi-dimensional vectors of the test data within the period of time; and

weight the normalized multi-dimensional vectors of the test data within the period of time, calculate distance from the weighted normalized multi-dimensional vectors to the best data vectors, and determine a grade of the network node according to the distance and a predefined monotonically decreasing function.

In this embodiment, the functions of the apparatus for evaluating node performance described in Embodiment 1 are incorporated herein, and shall not be described herein any further.

In another implementation, the apparatus for evaluating node performance described in Embodiment 1 and the central processing unit 701 may be configured separately. For example, the apparatus for evaluating node performance described in Embodiment 1 may be configured as a chip connected to the central processing unit 701, with its functions being realized under control of the central processing unit 701.

Furthermore, as shown in FIG. 7, the control entity 700 may include a transceiver 703, and an antenna 704, etc. In this embodiment, functions of the above components are similar to those in the prior art, and shall not be described herein any further. It should be noted that the control entity 700 does not necessarily include all the parts shown in FIG. 7, and furthermore, the control entity 700 may include parts not shown in FIG. 7, and the prior art may be referred to.

With the control entity of the embodiment of this disclosure, by collecting real-time communication related information of the network node in the wireless network, performing statistical analysis on the collected information, and performing node performance evaluation by using a method for comparing the training data and the test data, thereby providing references for network service providers in performing network optimization.

### Embodiment 3

An embodiment of this disclosure further provides a communication system. FIG. 8 is a schematic diagram of topology of the system. As shown in FIG. 8, the system 800 includes a coordinator 801 and terminal equipment 802.

In this embodiment, the system 800 may further include a control entity 803, which may be carried out by the control entity in Embodiment 2. Furthermore, the functions of the apparatus for evaluating node performance of the control entity may be integrated into the coordinator 801. As the apparatus for evaluating node performance and the control entity are described in detail in Embodiment 1 and Embodiment 2, their contents are incorporated herein, and shall not be described herein any further.

In this embodiment, the control entity may be a coordinator, a gateway, a central controller, or a cloud, etc.

With the system of the embodiment of this disclosure, by collecting real-time communication related information of the network node in the wireless network, performing statistical analysis on the collected information, and performing node performance evaluation by using a method for comparing the training data and the test data, thereby providing references for network service providers in performing network optimization.

### Embodiment 4

An embodiment of this disclosure provides a method for evaluating node performance, applicable to control entity in a wireless network, such as a coordinator, an access point, a central controller, or a cloud, etc. As principles of the method for solving problems are identical to that of the apparatus of Embodiment 1, the implementation of the apparatus of Embodiment 1 may be referred to for implementation of the method, with identical contents being not going to be described herein any further.

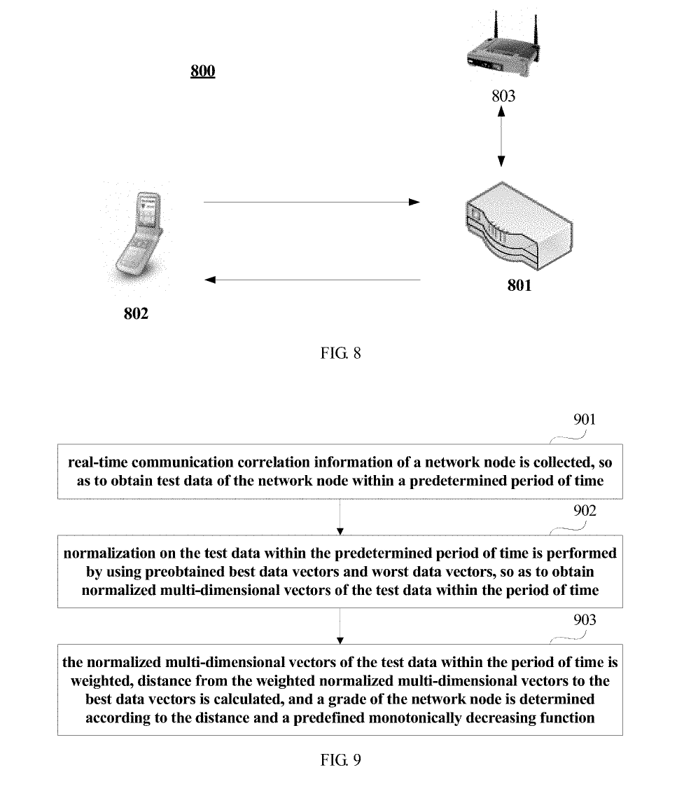

FIG. 9 is a schematic diagram of the method. As shown in FIG. 9, the method includes:

step 901: real-time communication related information of a network node is collected, so as to obtain test data of the network node within a predetermined period of time;

wherein, the test data includes one or more of the following or a combination thereof:
a packet drop ratio;
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

step 902: normalization on the test data within the predetermined period of time is performed by using preobtained best data vectors and worst data vectors, so as to obtain normalized multi-dimensional vectors of the test data within the period of time; and

step 903: the normalized multi-dimensional vectors of the test data within the period of time is weighted, distance from the weighted normalized multi-dimensional vectors to the best data vectors is calculated, and a grade of the network node is determined according to the distance and a predefined monotonically decreasing function.

In an implementation of this embodiment, the best data vectors and worst data vectors are obtained by training. For example, communication related information of all nodes in a wireless network in different training circumstances within a predetermined period of time is collected to obtain training data, and the best data vectors and worst data vectors are found according to all training data of all the nodes.

In this implementation, the training data includes one or more of the following indices or a combination thereof:

a packet drop ratio PDR;

a retry ratio;

a channel state busy ratio channel_busy_ratio;

an average correlation values corr_avg of all ACKs within the predetermined period of time;

an average value of RSSI values rssi_avg of all the ACKs within the predetermined period of time; and

an average value rssi_grad of all absolute values of gradients of the RSSIs of all the ACKs within the predetermined period of time.

In this implementation, the best data vectors include a best value of each index in all the training data, and the worst data vectors include a worst value of each index in all the training data.

In another implementation of this embodiment, the best data vector and the worst data vector are received from the coordinators. In this implementation, by using the best data vectors and worst data vectors reported by a coordinator, a network node in communication with the coordinator is graded. That is, different grade criteria are adopted for different terminal equipment in communication with different coordinators. For example, the best data vectors and worst data vectors reported by the coordinators are received, and the normalization on the test data of the network node within the predetermined period of time is performed by using the best data vectors and worst data vectors reported by the coordinators.

In a further implementation of this embodiment, the best data vector and the worst data vector are also received from the coordinators. In this implementation, by using the best data vectors and worst data vectors reported by all the coordinators, a best data vector and a worst data vector are found to grade the network node, that is, the same criterion is used to grade all network nodes. For example, best data vectors and worst data vectors reported by coordinators are received, and final best data vectors and worst data vectors are selected from all the best data vectors and worst data vectors, and the normalization on the test data of the network node within the predetermined period of time is performed by using the final best data vectors and worst data vectors.

In still another implementation of this embodiment, if a certain index of the test data exceeds a range of a corresponding index in the final best data vectors or the worst data vectors, the index of the test data may be saved as a corresponding index in new best data vectors or new worst data vectors, and the normalization on the test data of the network node within the predetermined period of time is performed by using the new best data vectors and the new worst data vectors.

In an implementation of step 902, the normalization on the test data of the network node within the period of time may be performed by using a formula as below, so as to obtain each dimension of vector of the normalized multi-dimensional vectors of the test data:

$${d}^{ i} = \frac{{d}_{test}^{ i} - {d}_{best}^{ i}}{{d}_{worst}^{ i} - {d}_{best}^{ i}} ;$$

where, dⁱ is an i-th dimension of the normalized multi-dimensional vectors, dⁱₜₑₛₜ is an i-th dimension of the test data of the network node within the period of time, dⁱ_{best} is an i-th dimension of the best data vectors, and dⁱ _{worst} is an i-th dimension of the worst data vectors.

In an implementation of step 903, the normalized multi-dimensional vectors of the test data are graded by using a formula as below:

$$grade = {e}^{- \frac{\vert w \cdot D \vert}{\vert w \vert}} ⋆ 100 ;$$

where, D is the normalized multi-dimensional vectors of the network node, w is a weighted vector, and each element of w being wᵢ≧0 (i denoting an i-th dimension).

In this embodiment, according to the method of this embodiment, whether there exists a failure in the network node is determined based on the grade of the network node and the threshold value.

With the method of the embodiment of this disclosure, by collecting real-time communication related information of the network node in the wireless network, performing statistical analysis on the collected information, and performing node performance evaluation by using a method for comparing the training data and the test data, thereby providing references for network service providers in performing network optimization.

An embodiment of the present disclosure further provides a computer readable program code, which, when executed in a control entity in a wireless network, will cause a computer to carry out the method as described in Embodiment 4 in the control entity in the wireless network.

An embodiment of the present disclosure further provides a computer readable medium, including a computer readable program code, which will cause a computer to carry out the method as described in Embodiment 4 in a control entity in a wireless network.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

For implementations of the present disclosure containing the above embodiments, following supplements are further disclosed.

Supplement 1. An apparatus for evaluating node performance, including:

a collecting unit configured to collect real-time communication related information of a network node, so as to obtain test data of the network node within a predetermined period of time, the test data including one or more of the following or a combination thereof:
a packet drop ratio (PDR);
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

a processing unit configured to perform normalization on the test data within the predetermined period of time by using preobtained best data vectors and worst data vectors, so as to obtain normalized multi-dimensional vectors of the test data within the period of time; and

a determining unit configured to weight the normalized multi-dimensional vectors of the test data within the period of time, calculate distance from the weighted normalized multi-dimensional vectors to the best data vectors, and determine a grade of the network node according to the distance and a predefined monotonically decreasing function.

Supplement 2. The apparatus according to supplement 1, wherein the apparatus further includes:

a training unit configured to collect communication related information of all nodes in a wireless network in different training circumstances within a predetermined period of time to obtain training data, and find out the best data vectors and worst data vectors according to all training data of all the nodes.

Supplement 3. The apparatus according to supplement 2, wherein the training data include one or more of the following indices or a combination thereof:

a packet drop ratio;

a retry ratio;

a channel state busy ratio;

an average correlation values of all ACKs within the predetermined period of time;

an average value of RSSI values of all the ACKs within the predetermined period of time; and

an average value of all absolute values of gradients of the RSSIs of all the ACKs within the predetermined period of time.

Supplement 4. The apparatus according to supplement 2, wherein,

the best data vectors include a best value of each index in all the training data;

and the worst data vectors include a worst value of each index in all the training data.

Supplement 5. The apparatus according to supplement 1, wherein the apparatus further includes:

a first receiving unit configured to receive best data vectors and worst data vectors reported by coordinators;

and the processing unit performs the normalization on the test data of the network node within the predetermined period of time by using the best data vectors and worst data vectors reported by the coordinators.

Supplement 6. The apparatus according to supplement 1, wherein the apparatus further includes:

a second receiving unit configured to receive best data vectors and worst data vectors reported by coordinators, and select final best data vectors and worst data vectors from all the best data vectors and worst data vectors;

and the processing unit performs the normalization on the test data of the network node within the predetermined period of time by using the final best data vectors and worst data vectors.

Supplement 7. The apparatus according to supplement 1, wherein the apparatus further includes:

an updating unit configured to, when an index of the test data exceeds a range of a corresponding index in the best data vectors or the worst data vectors, save the index of the test data as a corresponding index in new best data vectors or new worst data vectors;

and the processing unit performs the normalization on the test data of the network node within the predetermined period of time by using the new best data vectors and new worst data vectors.

Supplement 8. The apparatus according to supplement 1, wherein the processing unit performs the normalization on the test data of the network node within the predetermined period of time by using a formula below, so as to obtain each dimension of vector of the normalized multi-dimensional vectors of the test data:

$${d}^{ i} = \frac{{d}_{test}^{ i} - {d}_{best}^{ i}}{{d}_{worst}^{ i} - {d}_{best}^{ i}} ;$$

where, dⁱ is an i-th dimension of the normalized multi-dimensional vectors, dⁱₜₑₛₜ is an i-th dimension of the test data of the network node within the period of time, dⁱ_{best} is an i-th dimension of the best data vectors, and dⁱ_{worst} is an i-th dimension of the worst data vectors.

Supplement 9. The apparatus according to supplement 1, wherein the determining unit determines a grade of the normalized multi-dimensional vectors of the test data by using a formula as below:

$$grade = {e}^{- \frac{\vert w \cdot D \vert}{\vert w \vert}} ⋆ 100 ;$$

where, D is the normalized multi-dimensional vectors of the network node, w is a weighted vector, each element of w being wᵢ≧0, and i denotes an i-th dimension.

Supplement 10. The apparatus according to supplement 9, wherein the apparatus further includes:

a failure detecting unit configured to determine whether there exists a failure in the network node according to a grade of the network node and a threshold value.

Supplement 11. A control entity in a wireless network, including an apparatus for evaluating node performance, the apparatus being configured to:

collect real-time communication related information of a network node, so as to obtain test data of the network node within a predetermined period of time, the test data including one or more of the following or a combination thereof:
a packet drop ratio (PDR);
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

perform normalization on the test data within the predetermined period of time by using preobtained best data vectors and worst data vectors, so as to obtain normalized multi-dimensional vectors of the test data within the period of time; and

weight the normalized multi-dimensional vectors of the test data within the period of time, calculate distance from the weighted normalized multi-dimensional vectors to the best data vectors, and determine a grade of the network node according to the distance and a predefined monotonically decreasing function.

Supplement 12. A communication system, including a coordinator and terminal equipment in communication with the coordinator; wherein, the communication system further includes a control entity, the control entity being configured to:

collect real-time communication related information of a network node, so as to obtain test data of the network node within a predetermined period of time, the test data including one or more of the following or a combination thereof:
a packet drop ratio (PDR);
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;

perform normalization on the test data within the predetermined period of time by using preobtained best data vectors and worst data vectors, so as to obtain normalized multi-dimensional vectors of the test data within the period of time; and

weight the normalized multi-dimensional vectors of the test data within the period of time, calculate distance from the weighted normalized multi-dimensional vectors to the best data vectors, and determine a grade of the network node according to the distance and a predefined monotonically decreasing function.

1. An apparatus for evaluating node performance, comprising:
a collecting unit configured to collect real-time communication related information of a network node, so as to obtain test data of the network node within a predetermined period of time, the test data comprising one or more of the following or a combination thereof:
a packet drop ratio;
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;
a processing unit configured to perform normalization on the test data within the predetermined period of time by using preobtained best data vectors and worst data vectors, so as to obtain normalized multi-dimensional vectors of the test data within the period of time; and
a determining unit configured to weight the normalized multi-dimensional vectors of the test data within the period of time, calculate distance from the weighted normalized multi-dimensional vectors to the best data vectors, and determine a grade of the network node according to the distance and a predefined monotonically decreasing function.

2. The apparatus according to claim 1, wherein the apparatus further comprises:
a training unit configured to collect communication related information of all nodes in a wireless network in different training circumstances within a predetermined period of time to obtain training data, and find out the best data vectors and worst data vectors according to all training data of all the nodes.

3. The apparatus according to claim 2, wherein the training data comprise one or more of the following indices or a combination thereof:
a packet drop ratio;
a retry ratio;
a channel state busy ratio;
an average correlation values of all ACKs within the predetermined period of time;
an average value of RSSI values of all the ACKs within the predetermined period of time; and
an average value of all absolute values of gradients of the RSSIs of all the ACKs within the predetermined period of time.

4. The apparatus according to claim 2, wherein,
the best data vectors comprise a best value of each index in all the training data;
and the worst data vectors comprise a worst value of each index in all the training data.

5. The apparatus according to claim 1, wherein the apparatus further comprises:
a first receiving unit configured to receive best data vectors and worst data vectors reported by coordinators;
and the processing unit performs the normalization on the test data of the network node within the predetermined period of time by using the best data vectors and worst data vectors reported by the coordinators.

6. The apparatus according to claim 1, wherein the apparatus further comprises:
a second receiving unit configured to receive best data vectors and worst data vectors reported by coordinators, and select final best data vectors and worst data vectors from all the best data vectors and worst data vectors;
and the processing unit performs the normalization on the test data of the network node within the predetermined period of time by using the final best data vectors and worst data vectors.

7. The apparatus according to claim 1, wherein the apparatus further comprises:
an updating unit configured to, when an index of the test data exceeds a range of a corresponding index in the best data vectors or the worst data vectors, save the index of the test data as a corresponding index in new best data vectors or new worst data vectors;
and the processing unit performs the normalization on the test data of the network node within the predetermined period of time by using the new best data vectors and new worst data vectors.

8. The apparatus according to claim 1, wherein the processing unit performs the normalization on the test data of the network node within the predetermined period of time by using a formula below, so as to obtain each dimension of vector of the normalized multi-dimensional vectors of the test data:
$${d}^{ i} = \frac{{d}_{test}^{ i} - {d}_{best}^{ i}}{{d}_{worst}^{ i} - {d}_{best}^{ i}} ;$$
where, dⁱ is an i-th dimension of the normalized multi-dimensional vectors, dⁱₜₑₛₜ is an i-th dimension of the test data of the network node within the period of time, dⁱ_{best} is an i-th dimension of the best data vectors, and dⁱ_{worst} is an i-th dimension of the worst data vectors.

9. The apparatus according to claim 1, wherein the determining unit determines a grade of the normalized multi-dimensional vectors of the test data by using a formula below:
$$grade = {e}^{- \frac{\vert w \cdot D \vert}{\vert w \vert}} ⋆ 100 ;$$
where, D is the normalized multi-dimensional vectors of the network node, w is a weighted vector, each element of w being wᵢ≧0, and i denotes an i-th dimension.

10. The apparatus according to claim 9, wherein the apparatus further comprises:
a failure detecting unit configured to determine whether there exists a failure in the network node according to a grade of the network node and a threshold value.

11. A control entity in a wireless network, including an apparatus for evaluating node performance, the apparatus being configured to:
collect real-time communication related information of a network node, so as to obtain test data of the network node within a predetermined period of time, the test data including one or more of the following or a combination thereof:
a packet drop ratio (PDR);
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;
perform normalization on the test data within the predetermined period of time by using preobtained best data vectors and worst data vectors, so as to obtain normalized multi-dimensional vectors of the test data within the period of time; and
weight the normalized multi-dimensional vectors of the test data within the period of time, calculate distance from the weighted normalized multi-dimensional vectors to the best data vectors, and determine a grade of the network node according to the distance and a predefined monotonically decreasing function.

12. A communication system, including a coordinator and terminal equipment in communication with the coordinator; wherein, the communication system further includes a control entity, the control entity being configured to:
collect real-time communication related information of a network node, so as to obtain test data of the network node within a predetermined period of time, the test data including one or more of the following or a combination thereof:
a packet drop ratio (PDR);
a retry ratio;
a channel state busy ratio (chan_busy_ratio);
an average correlation value (corr_avg) of all acknowledgements (ACKs) within the predetermined period of time;
an average value (rssi_avg) of received signal strength indicator (RSSI) values of all the ACKs within the predetermined period of time; and
an average value (rssi_grad) of all absolute values of gradients of the RSSIs of all the ACKs within the predetermined period of time;
perform normalization on the test data within the predetermined period of time by using preobtained best data vectors and worst data vectors, so as to obtain normalized multi-dimensional vectors of the test data within the period of time; and
weight the normalized multi-dimensional vectors of the test data within the period of time, calculate distance from the weighted normalized multi-dimensional vectors to the best data vectors, and determine a grade of the network node according to the distance and a predefined monotonically decreasing function.
